(19) United States
(12) Patent Application Publication
(10) Pub. No.: US 2002/0138395 A1
(43) Pub. Date: Sep. 26, 2002

(54) Customized internet service attribute comparison

(76) Inventors: Narasimha R. Edala, Chandler, AZ (US); Christian R. Thomas, Scottsdale, AZ (US); Srinivasan Krishnamurthy, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/802,429

(22) Filed: Mar. 9, 2001

(51) Int. Cl. G06F 17/60

(52) U.S. Cl. 705/37

(57) ABSTRACT

A method is provided for clients to receive services that match client-desired attributes. In an aspect, attributes and comparison operators submitted by a client and a service are compared using a comparison function. In an aspect, the data type and/or the context of the client attribute and the service attribute differ, the service attribute is tagged and a pointer directs a broker to a uniform resource identifier (URI). The URI refers to a specialized comparison function that can properly compare the differing client attribute and service attribute, the specialized comparison function maintained current by the service.

### FIELD

This invention relates to attribute comparison, more particularly, matching client attributes and service attributes that have varying data types and varying contexts, using a specialized comparison function that is maintained current.

### BACKGROUND

Internet searching strategies include creative guessing of Uniform Resource Locators (URLs), and use of subject directories and search engines. Search Engines find and index as many internet sites as possible. Search features vary greatly, as do the actual scope, size, and accuracy of databases. In order for a client to locate an internet service of interest, a boolean search, using attributes and comparison operators, including OR and AND, are frequently necessary to handle a clients inquiry. Current technologies, including Jini, Salutation, E-Speak and Universal Description, Discovery and Integration (“UDDI”) utilize comparison functions to perform comparisons that include comparison operators. Current technology comparison functions can adequately make comparisons, using comparison operators including “less than,” “greater than,” and “equal to” between attributes being the same data type.

### BRIEF DESCRIPTION OF THE DRAWINGS

Additional advantages of the invention will become apparent upon reading the following detailed description and upon reference to the drawings, in which:

FIG. 1 depicts a representation of the interaction of four invention components in an embodiment of the invention;

FIG. 2 is a flow diagram depicting the operation of an embodiment of the invention;

FIG. 3 depicts a flow diagram depicting Broker functions, in an embodiment of the invention;

FIG. 4 depicts a flow diagram depicting Service functions, in an embodiment of the invention; and

FIG. 5 depicts a flow diagram depicting Client functions, in an embodiment of the invention.

### DETAILED DESCRIPTION

Exemplary embodiments are described with reference to specific configurations. Those of ordinary skill in the art will appreciate that various changes and modifications can be made while remaining within the scope of the appended claims.

Current technologies make comparisons between attributes of the same data type. However, attributes submitted by a client and a service are not always the same data type and, in these cases, the current technologies fail to make reliable comparisons. In an embodiment, the present invention provides a method for comparing client submitted attributes and internet service submitted attributes that are not the same data type, and provides a reliable and desired result. For example, when a client submits an attribute of the type “1200” and an internet service submits an attribute “twelve hundred,” having a different data type, the present invention provides a customized comparison function, hereinafter termed “specialized comparison function,” to compare these attributes. The specialized comparison function is provided by an internet service, sometimes also referred to (in the appended claims) as “internet service provided comparison function.”

While current comparison engines including Jini, Salutation, E-Speak and UDDI utilize comparison functions, they fail to treat attributes in a particular context. For example, in some cases, a number submitted by a Client represents a zip code, in other cases a number submitted by a Client represents a price or a distance. As another example, client attributes and service attributes can have varying contexts. As another example, a client can submit an attribute “high resolution” as a desired printer, and a service can submit an attribute “1200 dpi” as an offered resolution. In this case a comparison function must have the ability and capacity to compare “high resolution” with “1200 dpi.” In an embodiment, the invention provides a specialized comparison function, such that attributes submitted by a client and attributes submitted by a service having varying contexts are compared on a case-by-case basis, and current and useful comparison results are generated. The specialized comparison function is provided by an internet service.

Current technology comparison functions can adequately make comparisons of attributes having comparison operators including “equal to,” “less than” and “greater than,” but for many attribute contexts, such comparisons are not useful. In an embodiment, the invention provides a specialized comparison function to manage additional comparison operators and attribute contexts.

Moreover, attribute context and operator context can change with time, and whereas current technologies fail to make reliable comparisons, an embodiment of the invention provides a method of making comparisons using current information. For example, when a client submits an attribute such as “purchase a pizza” along with a comparison operator such as “within one mile,” the comparison conditions change with time. That is, new pizza restaurants open and existing pizza restaurants close continuously over time. Therefore, comparison functions must be continuously updated. A service is better situated to maintain a the continuously updated (current) comparison function. An embodiment of the invention provides a specialized comparison function to make a comparison using current information. The specialized comparison function is provided by the internet service.

In an embodiment, attributes are submitted by a client and a service, and are compared using a comparison function. In an embodiment, at least one comparison operator is submitted by at least one of a client and a service. In an embodiment, a broker coordinates the attribute comparison. In an embodiment, attributes submitted by a client and attributes submitted by a service can be satisfactorily compared by a broker-provided comparison function, hereinafter termed “default comparison function”. In an embodiment, the data type and/or the context of the client attribute and the service attribute differ, the service attribute is tagged by the service, and a pointer directs a broker to a uniform resource identifier (URI). The URI refers to a specialized comparison function that can properly compare the differing client attribute and service attribute, the specialized comparison function maintained current by the service. In an embodiment, the specialized comparison function, referred to by the URI, is downloaded, and optionally cached, to the broker for a broker comparison engine to perform the specialized comparison. In an embodiment, the specialized comparison function, referred to by the URI, performs the specialized comparison remotely from the broker, and transmits the comparison results to the broker. In an embodiment, the broker has the option (depending on broker feasibility) of either downloading the specialized comparison function and perform the specialized comparison locally, or having a remote comparison engine perform the specialized comparison remotely. In an embodiment the specialized comparison function downloaded by the broker is a binary to be used at runtime. In an embodiment, a service submits tagged attributes and non-tagged attributes to a broker, the service making the decision whether to tag attributes. In an embodiment, the decision whether to tag an attribute is individually made as to each individual client attribute. Additionally, in an embodiment, the decision whether to tag an attribute is based on considerations including client attribute data type, context, etc.

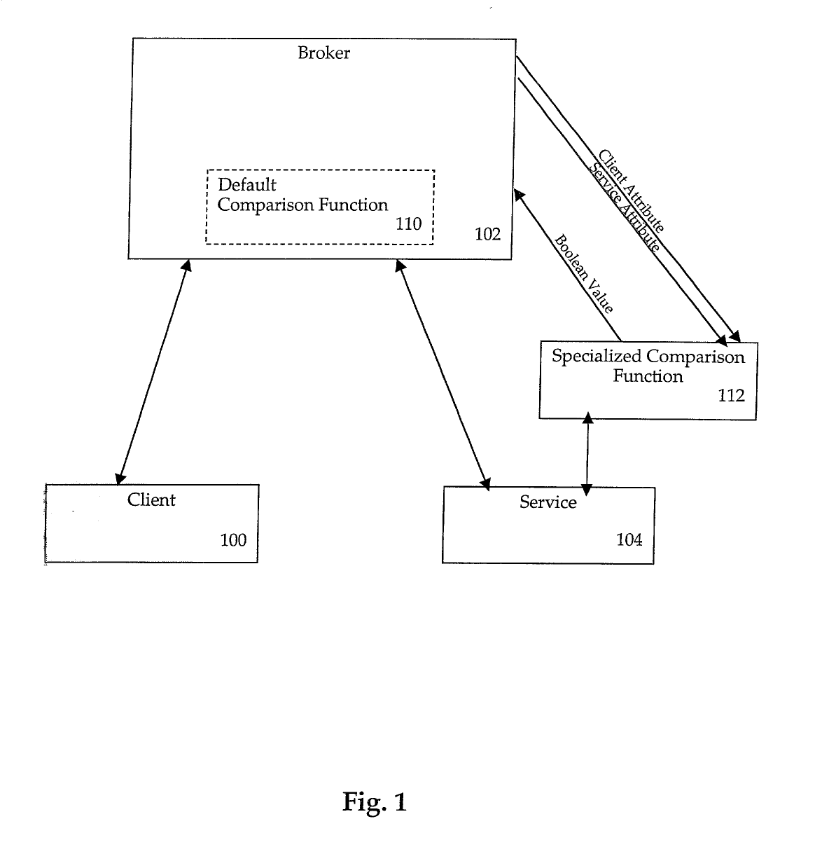

As exhibited in FIG. 1, five components including Client 100, Broker 102, Service 104, default comparison function 110, and specialized comparison function 112 interact in an embodiment of the invention. Client 100 interacts with Broker 102, and Service 104 interacts with Broker 102. In an embodiment, Broker 102 utilizes default comparison function 110 in making a comparison of Client 100 attributes and Service 104 attributes. In an embodiment, Broker 102 utilizes specialized comparison function 112 in making a comparison of Client 100 attributes and Service 104 attributes. In an embodiment, Client 100 attributes and service 104 attributes are passed to at least one of default comparison function 110 and specialized comparison function 112 utilizing metadata strings. In an embodiment, a boolean value indicating the success or the failure of the comparison is passed to Broker 102.

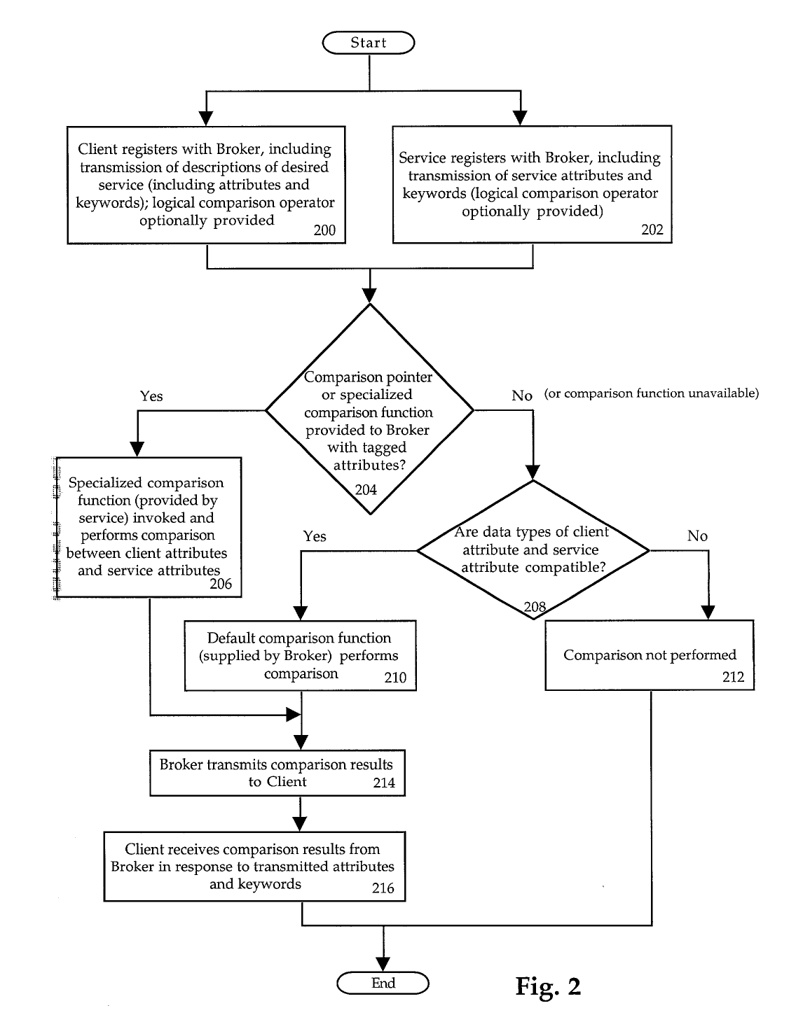

An embodiment of the invention is shown in FIG. 2. As shown in functional block 200, Client 100 registers with Broker 102, including the transmission of descriptions of desired services. In an embodiment, the descriptions of desired services includes attributes and keywords. In an embodiment, at least one logical comparison operator is provided by Client 100 to Broker 102. As shown in functional block 202, Service 104 registers with Broker 102, including the transmission of service attributes and keywords. In an embodiment, at least one logical comparison operator is provided by Service 104 to Broker 102. In an embodiment, Client 100, but not Service 104, provides a logical comparison operator to Broker 102.

As shown in decision block 204, it is determined whether Service 104 provides tagged attributes and either a specialized comparison function or a comparison pointer directing Broker 102 to a uniform resource identifier (URI). When an affirmative answer applies to decision block 204 then, as shown in functional block 206, specialized comparison function 112 is invoked and performs a comparison between Client 100 attributes and Service 104 attributes. In an embodiment, specialized comparison function 112 performs a comparison between Client 100 attributes and Service 104 attributes and additionally utilizes at least one logical comparison operator provided by at least one of Client 100 and Service 104. In an embodiment, specialized comparison function 112 accepts two metadata strings, one metadata string associated with Client 100 attribute and one metadata string associated with Service 104 attribute. In an embodiment, specialized comparison function 112 accepts parameters associated with Client 100 attribute and Service 104 attribute. In an embodiment, the metadata strings are one of extensible mark-up language (XML) strings, hypertext markup language (HTML), text file, binary, etc. In an embodiment, specialized comparison function 112 returns a boolean value to Broker 102 indicating the success or failure of a match. As shown in functional block 214, Broker 102 transmits comparison results to Client 100. As shown in functional block 216, Client 100 receives comparison results from Broker 102 in response to Client 100 transmitted descriptions of desired services.

When a negative answer applies to decision block 204 then, as shown in decision block 208, it is determined whether data types of Client 100 attributes and Service 104 attributes are compatible. When a negative answer applies to decision block 208 then, as shown in functional block 212, a comparison is not performed. When an affirmative answer applies to decision block 208 then, as shown in functional block 210, default comparison function 110, supplied by Broker 102, performs a comparison. As shown in functional block 214, Broker 102 transmits comparison results to Client 100. As shown in functional block 216, Client 100 receives comparison results from Broker 102 in response to Client 100 transmitted descriptions of desired services.

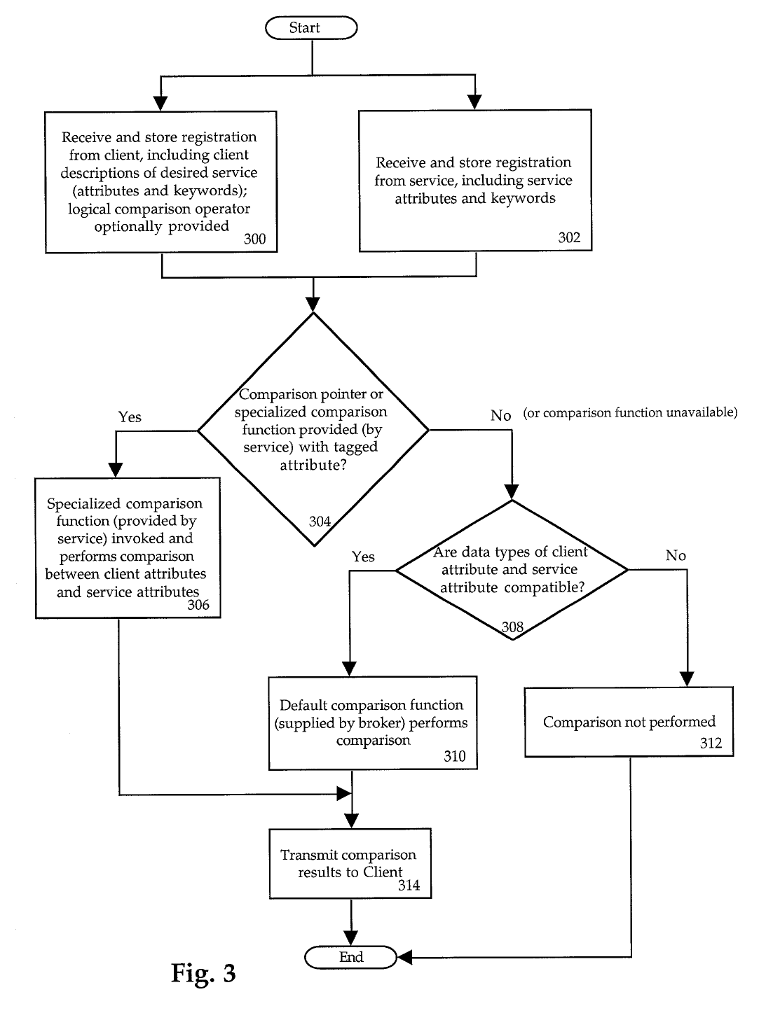

An embodiment of the invention is shown in FIG. 3. As shown in functional block 300, Broker 102 receives and stores registration information from Client 100, including Client 100 descriptions of desired services. In an embodiment, the descriptions include attributes and keywords. As shown in functional block 302, Broker 102 receives and stores registration information from Service 104. In an embodiment, the registration information includes attributes and keywords. In an embodiment, a logical comparison operator is provided by at least one of Client 100 and Service 104. In an embodiment, a logical comparison operator is not provided by either Client 100 or Service 104.

As shown in decision block 304, it is determined whether Service 104 attributes are tagged and either a specialized comparison function is provided or a comparison pointer directs Broker 102 to a URI. When an affirmative answer applies to decision block 304 then, as shown in functional block 306, specialized comparison function 112 is invoked and performs a comparison of Client 100 attributes and Service 104 attributes. As shown in functional block 314, Broker 102 transmits comparison results to Client 100.

When a negative answer applies to decision block 304 then, as shown in functional block 308, it is determined whether data types of Client 100 attributes and Service 104 attributes are compatible. When a negative answer applies to decision block 308 then, as shown in functional block 312, a comparison of Client 100 attributes and Service 104 attributes is not performed. When an affirmative answer applies to decision block 308, then, as shown in functional block 310, default comparison function 112, supplied by Broker 102, performs a comparison. As shown in functional block 314, Broker 102 transmits comparison results to Client 100.

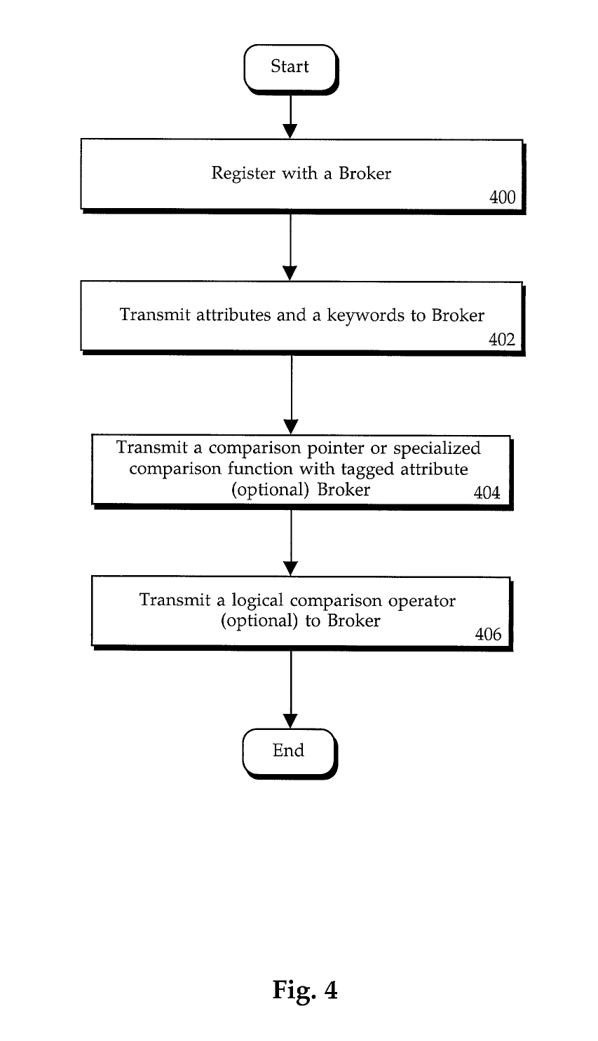

An embodiment of the invention is shown in FIG. 4. As shown in functional block 400, Service 104 registers with Broker 102. As shown in functional block 402, Service 104 transmits attributes and keywords to Broker 102. As shown in functional block 404, in an embodiment of the invention, Service 104 transmits a comparison pointer or function with tagged attributes to Broker 102. As shown in functional block 406, in an embodiment of the invention, Service 104 transmits a logical comparison operator to Broker 102.

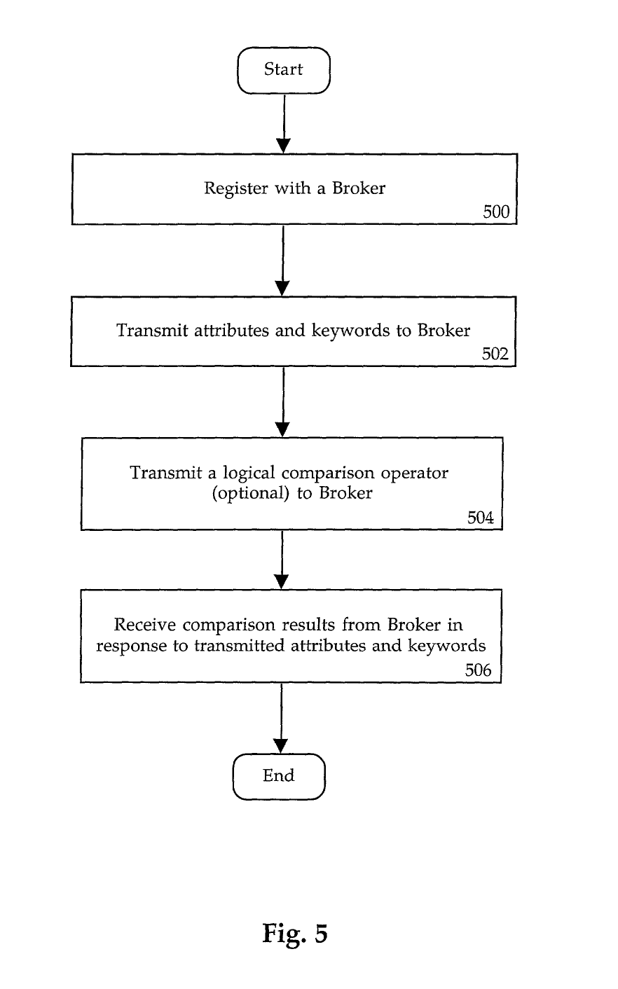

FIG. 5 represents an embodiment of the invention. As shown in functional block 500, Client 100 registers with Broker 102. In an embodiment, Client 100 registers with more than one Broker 102. As shown in functional block 502, Client 100 transmits attributes and keywords to Broker 102. As shown in functional block 504, in an embodiment of the invention, Client 100 transmits a logical comparison operator to Broker 102. As shown in functional block 506, Client 100 receives comparison results from Broker 102 in response to Client 100 transmitted attributes and keywords.

In an embodiment of the invention, a machine readable medium that is maintained current by a service is provided having instructions which when executed by a machine cause the machine to perform operations including compare a client attribute with a service attribute. In an embodiment, the client attribute and the service attribute have varying data types. In an embodiment, the client attribute and the service attribute have varying contexts. In an embodiment, the instructions of the machine readable medium are executed at a remote location from a broker. In an embodiment, instructions of the machine readable medium are executed at a location that is local to a broker. In an embodiment, the instructions of the machine readable medium, when executed, additionally considers in its comparison at least one logical comparison operator provided by at least one of a service and a client. The machine-readable storage medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Having disclosed exemplary embodiments, modifications and variations may be made to the disclosed embodiments while remaining within the spirit and scope of the invention as defined by the appended claims.

What is claimed is:

1. A method comprising:
registering with a broker; and
transmitting, to said broker, at least one attribute tagged for comparison by an internet service provided comparison function.

2. The method as in claim 1, further comprising:
transmitting at least one logical comparison operator to said broker.

3. The method as in claim 1, further comprising:
transmitting a comparison pointer with said attribute tagged for comparison, directing said broker to a uniform resource identifier (URI) for accessing said internet service provided comparison function.

4. The method as in claim 1, further comprising:
transmitting said internet service provided comparison function to said broker.

5. The method as in claim 1, wherein said transmitting further comprises transmitting metadata being at least one of extensible markup language (XML), hypertext markup language (HTML), text file, and binary.

6. The method as in claim 1, wherein said internet service provided comparison function compares attributes having at least one of varying data types and varying contexts, and is maintained current.

7. A method comprising:
registering with a broker;
transmitting at least one attribute to said broker; and
receiving current comparison results from said broker.

8. The method as in claim 7, further comprising:
transmitting at least one logical comparison operator to said broker.

9. The method as in claim 7, wherein said transmitting further comprises transmitting metadata being at least one of extensible markup language (XML), hypertext markup language (HTML), text file, and binary.

10. A method comprising:
receiving registration descriptions, including at least one attribute from a client;
receiving, from a service, at least one attribute tagged for comparison by an internet service provided comparison function;
invoking said internet service provided comparison function to perform at least one comparison of attributes from said client and said attribute tagged; and
providing comparison results to said client.

11. The method as in claim 10, further comprising:
receiving at least one logical comparison operator from at least one of said client and said internet service; and
transmitting said logical comparison operator to said internet service provided comparison function.

12. The method as in claim 10, further comprising
receiving a comparison pointer with said attribute tagged for comparison, directing to a uniform resource identifier (URI) for accessing said internet service provided comparison function; and
utilizing said internet service provided comparison function remotely from said broker.

13. The method as in claim 10, further comprising:
receiving a comparison pointer with said attribute tagged for comparison, directing to a uniform resource identifier (URI) for accessing said internet service provided comparison function;
downloading said internet service provided comparison function; and
utilizing said internet service provided comparison function locally by said broker.

14. The method as in claim 10, further comprising:
receiving said internet service provided comparison function with said attribute tagged for comparison.

15. The method as in claim 10, wherein said invoking further comprises transmitting metadata strings to said comparison function.

16. The method as in claim 10, wherein said invoking further comprises returning a boolean value indicating one of success and failure of said comparison.

17. The method as in claim 10, wherein said receiving attributes further comprises receiving metadata being at least one of extensible markup language (XML), hypertext markup language (HTML), text file, and binary.

18. The method as in claim 10, wherein said internet service provided comparison function compares an attribute from said client and an attribute from said service having at least one of varying data types and varying contexts, and is maintained current.

19. A machine readable medium having instructions which when executed by a machine cause said machine to perform operations comprising:
comparing a client attribute with a service attribute using current instructions updated by a service.

20. The machine readable medium as in claim 19, wherein said comparing comprises comparing said client attribute and said service attribute having varying data types.

21. The machine readable storage medium as in claim 19, wherein said comparing comprises comparing said client attribute and said service attribute have varying contexts.

22. The machine readable medium as in claim 19, wherein said comparing comprises comparing said client attribute and said service attribute at a remote location from a broker

23. The machine readable medium as in claim 19, wherein said comparing comprises comparing said client attribute and said service attribute at a location that is local to a broker.

24. The machine readable medium as in claim 19, wherein said comparing further comprises considering at least one logical comparison operator provided by at least one of said service and a client.
